(19) United States
(12) Patent Application Publication
(10) Pub. No.: US 2009/0153525 A1
(43) Pub. Date: Jun. 18, 2009

(54) Touch pen with erasure function

(75) Inventor: Sheng Lung Chang, Jhonghe City (TW)

Correspondence Address: HUDAK, SHUNK & FARINE, CO., L.P.A., 2020 FRONT STREET, SUITE 307, CUYAHOGA FALLS, OH, 44221, US

(73) Assignee: MITAC INTERNATIONAL CORP., TAOYUAN (TW)

(21) Appl. No.: 12/229,734

(22) Filed: Aug. 26, 2008

(30) Foreign Application Priority Data
Dec. 12, 2007 (TW) 096147553

(51) Int. Cl. G06F 3/033

(52) U.S. Cl. 345/179

(57) ABSTRACT

A touch pen with erasure function, applied for an electronic apparatus having a touch screen, comprises a body and a sensing unit. The body holds a accommodating space for disposing the sensing unit therein, and has a writing end and an erasing end. While detecting that the touch pen is held with the writing end located close to the touch screen, the sensing unit generates a first signal to the electronic device for allowing the touch pen to write a message on the touch screen. When detecting that the touch pen is held with the erasing end located close to the touch screen, the sensing unit generates a second signal to the electronic device for allowing the touch pen to erase the message on the touch screen.

### FIELD OF THE INVENTION

The present invention is related to a touch pen, and more particularly to a touch pen with erasure function.

### BACKGROUND OF THE INVENTION

FIG. 1 illustrates a three-dimensional view of a conventional touch pen and electronic device. The electronic device 1 can be one of a mobile phone, a personal digital assistant, or a global positioning system. The electronic device 1 comprises a touch screen 11 and the touch pen 12. The touch screen 11 is disposed on the electronic device 1. Touch pen 12 has a writing end 121. While applying the touch pen 12 for the electronic device 1, the user can hold the writing end 121 of the touch pen 12 to touch the touch screen 11 for writing a message on.

However, in the event a user finds any mistake in the message written on the touch screen, he/she has to delete the whole message and input the correct message again. In case of drawing a picture on the touch screen 11, the user has to use the touch pen 12 to click on an erasure item displayed on the touch screen to erase the picture. In common situation, the user may not feel he/she is wasting his time to do the above-mentioned action. However, when the touch pen is applied to write in shorthand in some special situation, action of deleting all message for correcting or clicking on the erasure item for erasing would inevitably waste much time and cause undesirable omission in the writing.

To satisfy the demand for incorporating the erasure function with the touch pen, so that a user may rapidly switch the touch pen between a write mode and an erase mode when applying the touch pen, the inventor devoted to extensive research and designs and discussions to the subject based on many years of the engagement in research and many practical experiences. As a result, the inventor proposes this invention which is a touch pen with erasure function, so as to be a realization method and basis of the said expectation.

### SUMMARY OF THE INVENTION

One of objectives of the present invention is to provide a touch pen with erasure function, particularly a touch pen internally equipped with a sensing unit, so that the touch pen may be applied not only to write a message on a touch screen of an electronic device by its writing end, but also to erase the message on the touch screen by its erasure end.

To achieve the aforesaid objective, the touch pen with erasure function comprises a body and a sensing unit. The body has a writing end and an erasing end, and holds an accommodating space. The sensing unit is disposed in the accommodating space. While detecting that the writing end is close to the touch screen, the sensing unit generates a first signal for the writing end to write a message on the touch screen. While detecting that the erasing end is close to the touch screen, the sensing unit generates a second signal for the erasing end to erase the message on the touch screen.

Preferably, the touch pen can further comprise a signal transmitter for transmitting the first signal and the second signal to the electronic apparatus.

Preferably, the sensing unit is a mercury switch, a mechanical-type switch and a gravity sensor (G-sensor).

### BRIEF DESCRIPTION OF THE DRAWINGS

The subject matter regarded as the invention is particularly pointed out and distinctly claimed in the concluding portion of the specification. The invention together with features and advantages thereof may best be understood by reference to the following detailed description with the accompanying drawings in which:

FIG. 1 is a three-dimensional view of a conventional touch pen and an electronic device;

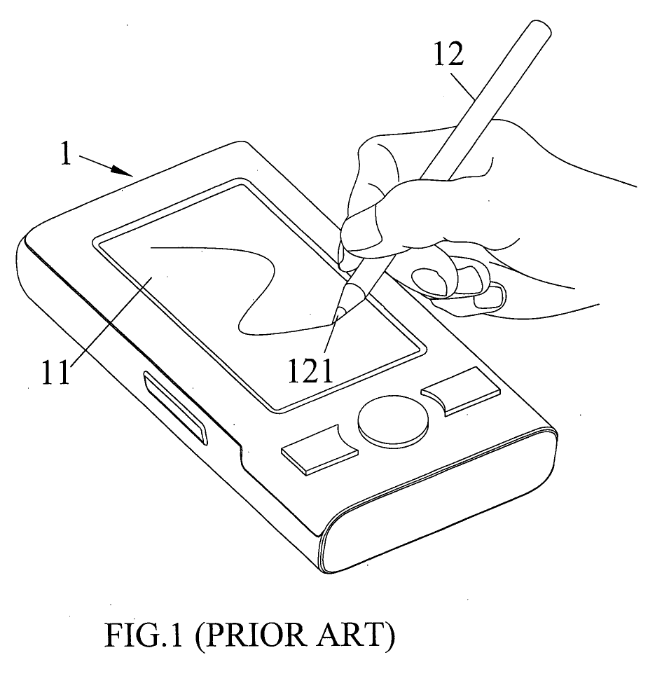

FIG. 2A is a three-dimensional view of the first embodiment of a touch pen with erasure function of the present invention;

FIG. 2B is a sectional view of the first embodiment of a touch pen with erasure function of the present invention;

FIG. 2C is a schematic view of using the first embodiment of the touch pen with erasing function of the present invention to write a message on the electronic device;

FIG. 2D is a schematic view of using the first embodiment of the touch pen with erasure function of the present invention to erase a message on the electronic device;

FIG. 3A is a sectional view of the second embodiment of a touch pen with erasure function of the present invention;

FIG. 3B is a schematic view of using the second embodiment of the touch pen with erasure function of the present invention to write a message on an electronic device; and

FIG. 3C is a schematic view of using the second embodiment of the touch pen with erasure function of the present invention to erase a message from the electronic device.

### DETAILED DESCRIPTION OF THE PREFERRED EMBODIMENTS

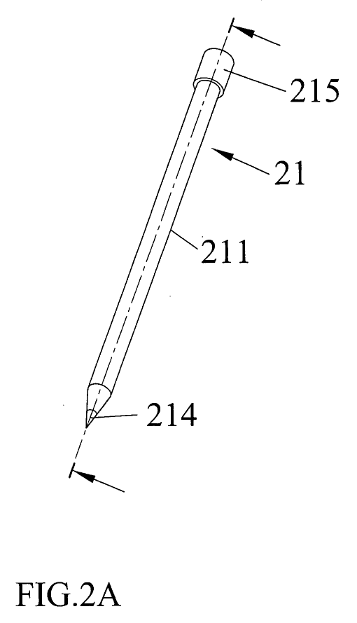

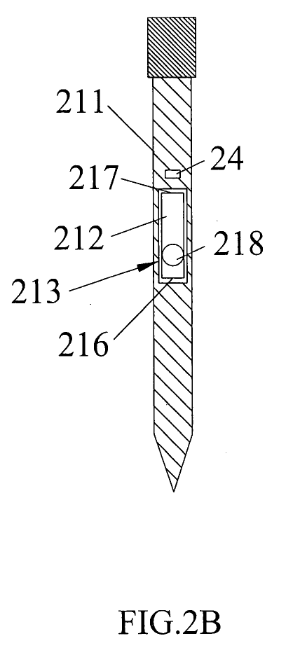

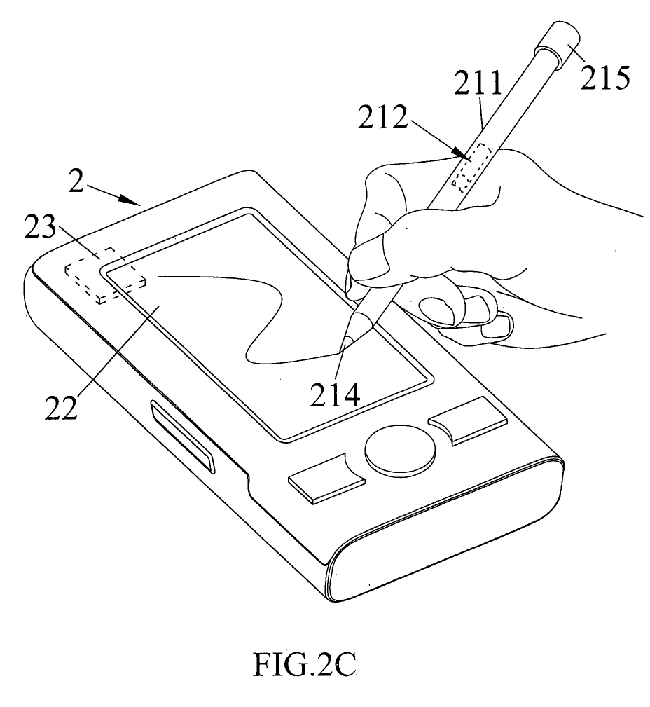

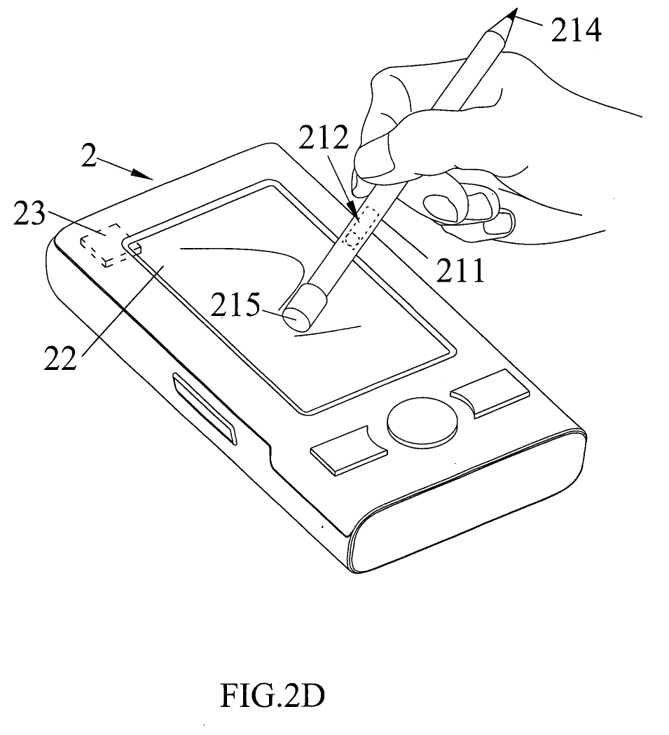

FIG. 2A to FIG. 2D illustrate a three-dimensional view, a sectional view, and an actuating view while being applied to the electronic device of the first embodiment of the touch pen with the erasure function of the present invention respectively. The touch pen 21 of the present invention can be applied on an electronic device 2 having a touch screen 22 and a signal receiver 23. The touch pen 21 at least comprises a body 211, a sensing unit 212 and a signal transmitter 24. Preferably, the electronic device 2 can be a cellular phone, a personal digital assistant (PDA), or a personal navigation device (PND).

The body 211 of the touch pen 21 holds an accommodating space 213, and has a writing end 214 and an erasing end 215. The body 211 appears in cylindrical shape, and the accommodating space 213 is located in the body 211. The writing end 214 and the erasing end 215 are separately located at two sides of the body 211. The writing end 214 appears in cone shape, so as to facilitate the user's writing on the touch screen 22.

The sensing unit 212 is disposed in the accommodating space 213 in the body 211 for sensing the status of the touch pen 21. The sensing unit 212 may alternatively be provided as for example, a gravity sensor (G-sensor), a mercury switch or a mechanical-type switch. The sensing unit 212 comprises a first part 216 closer to the writing end 214, a second part 217 closer to the erasing end 215, and a sensing element 218 located and displaceable between the first part 216 and the second part 217. The sensing element 218 is mercury if the sensing unit 212 is a mercury switch; or the sensing element 218 is an electric conductor when the sensing unit 212 is a mechanical-type switch.

When the touch pen 21 is held with the writing end 214 located lower and the erasing end 215 located higher, the sensing element 218 displaces to the first part 216 due to gravity and thereby causes the signal transmitter 24 to being actuated to transmit a first signal by using wire means or wireless means, such as Bluetooth, WiFi, or radio frequency identification (RFID) technique. Preferably, the signal transmitter 24 can be a Bluetooth module, WiFi module, RFID module, or USB module. The first signal is received by the signal receiver 23 and the electronic device 2 is activated to the writing state for allowing the touch pen 21 to write a message on the touch screen 22 of the electronic device 2.

While the touch pen 21 is held with the writing end 214 located higher and the erasing end 215 located lower, the sensing element 218 displaces to the second part 217 of the sensing unit 212 due to gravity, and thereby causes the signal transmitter 24 to being actuated to transmit the second signal. The second signal is received by the signal receiver 23 and the electronic device 2 is then activated to the erasing state for allowing the touch pen 21 to erase the message written on the touch screen 22.

A G-sensor can also serves as the sensing unit 212. When the user changes the position status of the writing end and the erasing end, the G-sensor can detect an acceleration generated by the rotation of the touch pen, and activate the signal transmitter 24 to transmit the first or the second signal based on the detected result.

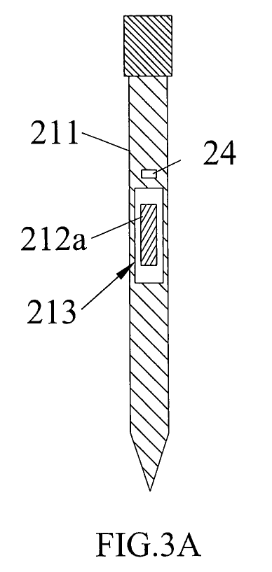

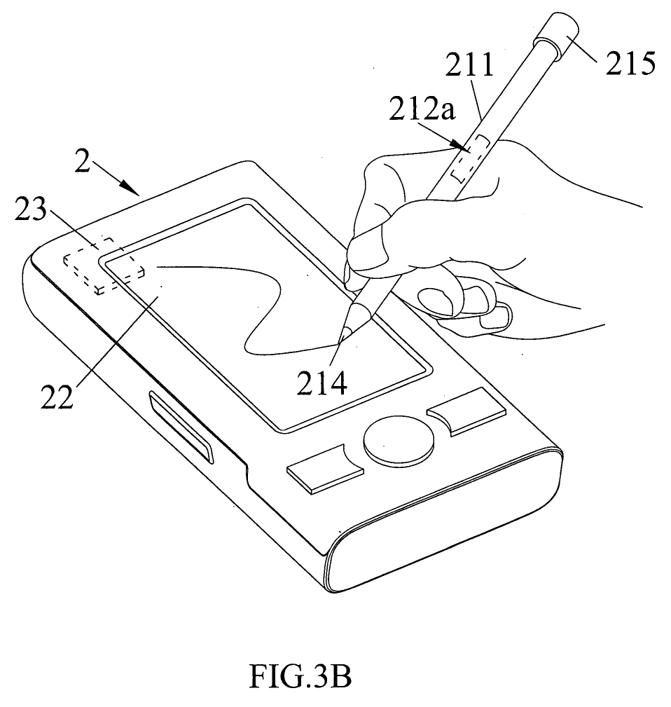

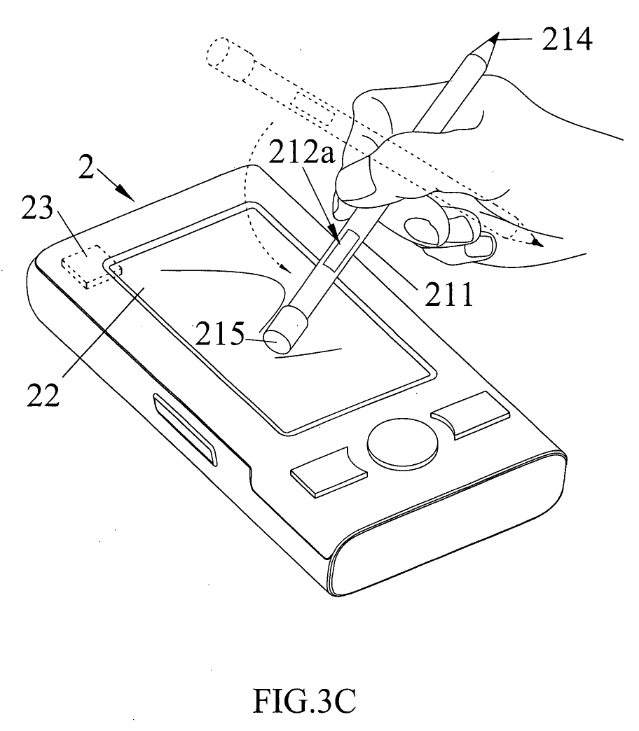

FIG. 3A to FIG. 3C illustrate a three-dimensional view, a sectional view, and an actuating view while being applied to the electronic device of second embodiment of the touch pen with erasure function of the present invention respectively. Compared with FIG. 2B, the sensing unit 212a is a G-sensor. While a user rotates the touch pen 21 to change the position status of the writing end 214 and the erasing end 215, the sensing unit 212a can detect the variation of acceleration and generated the first signal or the second signal based on the detected result. The signal transmitter 24 transmits the first signal or the second signal to the electronic device 2, so as to switch the electronic device 2 between the writing state and the erasing state, thereby touch pen 21 has the erasure function.

From the aforesaid content, the touch pen with erasure function of the present invention is improved by disposing a sensing unit in the touch pen, so that the writing end of the touch pen can be applied to write a message on touch screen, and the erasing end at the other end of the touch pen can be applied to erase the written message on touch screen, thereby the trouble of deleting the whole message and inputting the correct message again when facing a wrongly written message which always occurs in the prior art can be solved.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch pen with erasure function, applicable for an electronic apparatus having a touch screen, the touch pen comprising:
a body holding an accommodating space, and having a writing end and an erasing end; and
a sensing unit disposed in the accommodating space, wherein while detecting that the writing end located close to the touch screen, the sensing unit generates a first signal for allowing the writing end for writing a message on the touch screen, and while detecting that the erasing end located close to the touch screen, the sensing unit generates a second signal for allowing the erasing end for erasing the message on the touch screen.

2. The touch pen with erasure function of claim 1, wherein the electronic device has a signal receiver for receiving the first signal and the second signal.

3. The touch pen with erasure function of claim 1, further comprising a signal transmitter for transmitting the first signal and the second signal.

4. The touch pen with erasure function of claim 1, wherein the signal transmitter is a Bluetooth module, a WiFi module or a RFID module.

5. The touch pen with erasure function of claim 1, wherein the sensing unit is a mercury switch or a mechanical-type switch.

6. The touch pen with erasure function of claim 5, wherein the mercury switch generates the first signal or the second signal according to the location of mercury contained in the mercury switch.

7. The touch pen with erasure function of claim 5, wherein the mechanical-type switch generates the first signal and the second signal according to the location of an electric conductor contained in the mechanical-type switch.

8. The touch pen with erasure function of claim 1, wherein the sensing unit is a gravity sensor (G-sensor).

9. The touch pen with erasure function of claim 8, wherein when a user rotates the touch pen to change the position status of the writing end and the erasing end, the G-sensor detects an acceleration of the touch pen, and generates the first signal or the second signal based on the detected result.
